(19) United States
(12) Patent Application Publication
(10) Pub. No.: US 2020/0018587 A1
(43) Pub. Date: Jan. 16, 2020

(54) Electrical Displacement-, Load-, or Force Sensor

(71) Applicant: Technische Universiteit Delft, Delft (NL)

(72) Inventors: Cornelis van de Kamp, Delft (NL); Michael Fritschi, Delft (NL)

(21) Appl. No.: 16/577,731

(22) Filed: Sep. 20, 2019

Related U.S. Application Data
(63) Continuation of application No. PCT/NL2018/050183, filed on Mar. 23, 2018.

(30) Foreign Application Priority Data
Mar. 28, 2017 (NL) 2018591

(51) Int. Cl. G01B 7/00; G01B 7/16; G01L 1/14

(52) U.S. Cl. CPC G01B 7/003; G01L 1/14; G01B 7/16

(57) ABSTRACT

Electrical displacement-, load- or force sensor comprising a spring which is subjectable to a mechanical load or force and an inductive sensor element for measuring an electrical parameter that varies depending on said mechanical load or force on the spring, wherein the inductive sensor element is the spring and said spring is placed in series with an electrical circuit comprising in parallel a switching element and an RC circuit. The sensor can then be used to measure the load or force applied to the spring by arranging that the spring is energized through an electrical current flowing through the spring and through the current path with the switching element parallel to the RC circuit, and by subsequently interrupting the current from flowing through the current path parallel to the RC circuit and forcing it to flow through the RC circuit. A voltage decay time of an electrical energy received by the RC circuit upon interruption of the current flowing through the current path parallel to the RC circuit is then measured and used as a measure for the load or force applied to the spring.

### CROSS-REFERENCE TO RELATED APPLICATIONS

This application is a continuation of International Patent Application No. PCT/NL2018/050183, entitled “Electrical Displacement-, Load- or Force Sensor”, filed on Mar. 23, 2018, which claims priority to Netherlands Patent Application No. 2018591, entitled “Electrical Displacement-, Load- or Force Sensor”, filed on Mar. 28, 2017, and the specification and claims thereof are incorporated herein by reference.

### BACKGROUND OF THE INVENTION

Embodiments of the invention relate to an electrical displacement-, load- or force sensor comprising a spring, at least part of which spring is subjectable to a displacement, or to a mechanical load or force. The said displacement of a part of the spring is reflected in a length variation of the spring.

US2006/0293801 discloses a method for measuring a length variation of a spring, comprising the step of associating a sensor element with the spring and determining an impedance measurement of this sensor element, wherein on the basis of the impedance measurement the length variation of the spring is determined. It is taught that the sensor element can be an inductive or capacitive type sensor and that the sensor is crossed by a current to allow to obtain a variation of the electrical parameters of the sensor.

The article “Self-sensing of Displacement, Force and Temperature for Joule-Heated Twisted and Coiled Polymer Muscles via Electrical Impedance” by Joost van der Weijde et al; 2016 IEEE/ASME Transactions on Mechatronics, 1-1 discloses that displacement, force and temperature of such a muscle can be estimated with high precision and accuracy from measurements of the systems inductance and resistance.

Springs are everywhere; they are applied in furniture, cars, airplanes, robots, toys, mattresses etc. Occasionally it is required to measure the force or the load that is applied to the spring. It is known that for this purpose use can be made of load cells which measure the load to which the spring is subjected. This is disclosed in US 2006/0293801; this document intends to measure a length variation of the spring which requires that the load information is then processed in order to determine the extent of the elongation.

DE 32 05 705 A1 discloses an electrical displacement, load or force sensor comprising a spring of which a change of inductance is sensed as it deforms due to a displacement or a load. With a capacitor connected in parallel to the spring, the inductance of the spring is sensed as an oscillator frequency.

WO2008/090338 discloses to provide an indication of the displacement of a spring or alternatively of the load applied thereto by sensing the change of inductance of the spring as is displaced or as load is applied thereto. The spring is connected as an inductor in an electrical circuit with a capacitance, and the resonant frequency of the LC circuit is sensed to provide a measure of the inductance of the spring.

### BRIEF SUMMARY OF THE INVENTION

It is an object of one or more embodiments of the present invention to improve on the references described above in the Background of the Invention and to make the measurement of the length variation or displacement of the spring, or the force or load applied to the spring more easily measurable and at less cost.

Accordingly, it is an object of one or more embodiments of the present invention to lower the threshold of cost and complexity that applies to the prior art measurements.

According to an embodiment of the present invention an electrical displacement-, load- or force sensor is proposed in accordance with one or more of the appended claims. The invention is also embodied in a method for measuring a length variation of a spring or a displacement of a part of the spring, or for measuring a load or force applied to at least a part of a spring.

In a first aspect of an embodiment of the present invention, the inductive sensor element is embodied by the spring and said spring is placed in series with an electrical circuit comprising in parallel a switching element and an RC circuit.

This provides a very simple and cost-effective solution for measuring the length variation or displacement of part of the spring, or the force or load that is applied to the spring, since everything that is needed except for the spring is a simple electrical circuit that connects to the spring. In particular the separate inductive or capacitive elements that are required to be added in the sensor of US2006/0293801 are avoided, which limits cost and complexity.

Use of the electrical displacement-, load- or force sensor of the invention is also very simple. Measurement of a length variation or displacement, or a load or force applied to the spring is done by providing in a first step that the spring is energized through an electrical current flowing through the spring and through a current path parallel to the RC circuit. Then in a second step the electrical current flowing through the spring is interrupted from flowing through the current path parallel to the RC circuit and is forced to flow through the RC circuit, wherein a voltage decay time of an electrical energy thus received by the RC circuit upon interruption of the current flowing through the current path parallel to the RC circuit is measured and used as a measure for the load or force applied to the spring.

An advantageous feature of the embodiments of the present invention is therefore that an electrical parameter relative to the RC circuit is used as a measure for the length variation or displacement of part of the spring, or of the load or force applied to the spring. According to the principles of the invention, the measurement with the spring does not adversely affect the displacement of the relevant part of the spring, nor the applied load or force applied on the spring. The accuracy of the measurement is therefore at a very high level and unsurpassed by other measurement principles.

Suitably the measurement is enabled by arranging that the switching element has a first position in which electrical current is enabled to flow through the spring and through the switching element, and a second position in which electrical current through the switching element is interrupted and the current through the spring is forced to flow through the RC circuit.

Preferably the electrical parameter relative to the RC circuit is an electrical energy that a capacitor of the RC circuit receives from the spring when the switching element is moved into the second position in which electrical current through the spring is forced to flow through the RC circuit. The electrical energy received by the capacitor translates into a voltage over this capacitor. This is an adequate and easy to measure parameter that reflects the length variation or displacement of the spring, or the force or load applied to the spring when the current flow is interrupted.

Advantageously between the spring and the RC circuit an element is comprised that enables electrical current to flow from spring to RC circuit and that blocks electrical current to flow from RC circuit to spring. This prevents that the measurement of the length variation, or the load or force applied to the spring will be compromised by current flowing back to the spring. Preferably this element is a transistor or a diode. This is simple and cost-effective.

The measurement that indicates the length variation or displacement, or the force or load applied to the spring can suitably be carried out by arranging that the RC circuit connects to a comparator and a timer to measure a voltage decay time of the RC circuit.

Preferably the timer is started upon the switching element having moved into the second position in which electrical current through the spring is forced to flow through the RC circuit.

The switching element can in principle be hand operated, but it is preferred that the switching element is a transistor, preferably a MOSFET transistor. Measurement can then easily be executed without human intervention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a mattress with a cut-out view to show that the mattress has springs according to an embodiment of the invention;

FIG. 2 shows a first embodiment of a sensor according to an embodiment of the present invention with an electrical circuit including one spring;

FIG. 3 shows a second embodiment of a sensor according to an embodiment of the present invention with an electrical circuit including one spring;

FIG. 4 shows a driver signal of a switching element used in the second embodiment according to an embodiment of the present invention; and

FIG. 5 shows the decay voltage of an RC circuit applied in the second embodiment according to an embodiment of the present invention.

Whenever in the figures the same reference numerals are applied, these numerals refer to the same parts.

### DETAILED DESCRIPTION OF THE INVENTION

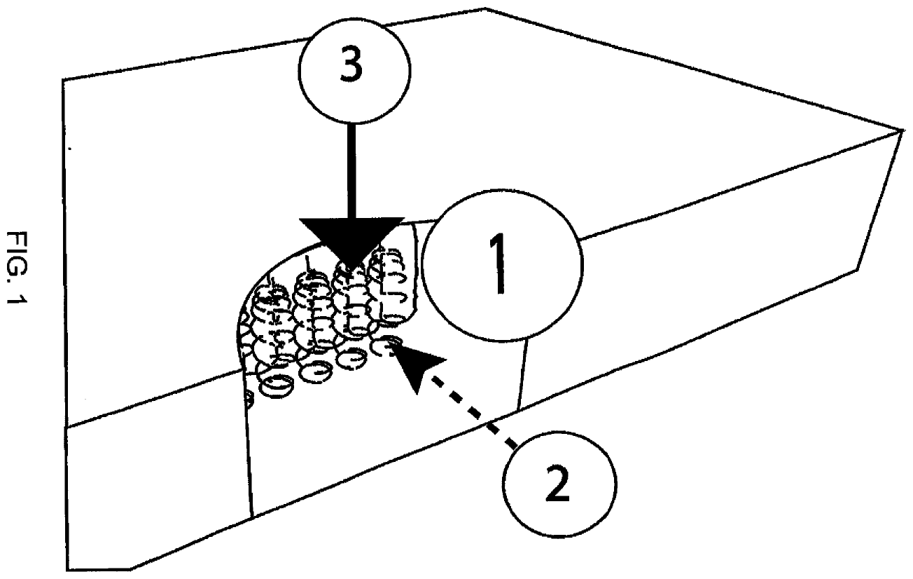

Making first reference to FIG. 1, it shows a mattress 1 in which through a cut-out view of the mattress 1 springs 2 are visible, which springs 2 are subjected to a length variation due to a force or load 3, wherein one of said parameters is intended to be measured. Such a mattress is only but one example of a product in which springs are present, wherein it may be of interest to measure the compression or length variation of the springs, or the forces or loads that are applied to the springs. There are however numerous other applications to which the various embodiments of the present invention apply, so that the invention is expressly not limited to measuring the displacements, forces or loads, or the distribution of displacements, forces or loads that are applied to a mattress. Other examples may be in the automotive field, in aeronautic engineering, in robotic applications, in medical applications, particularly laparoscopic surgery and many other fields that are as diverse as technology at large.

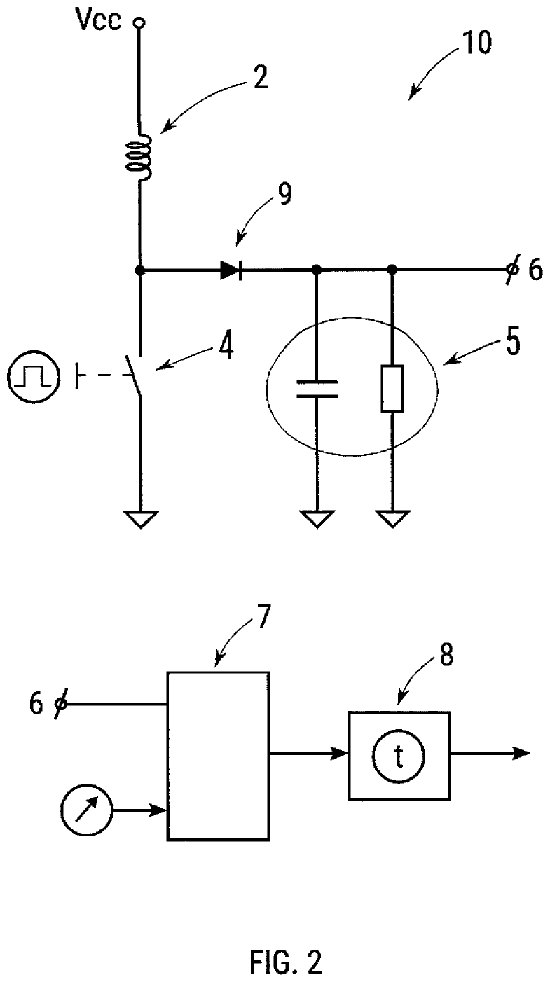

FIG. 2 shows a first embodiment of a sensor 10 according to an embodiment of the present invention in which one spring 2 is placed in series with an electrical circuit comprising in parallel a switching element 4 and an RC circuit 5. The spring 2 is energized through an electrical current flowing through the spring 2 and through a current path provided by the switching element 4 parallel to the RC circuit 5. In FIG. 2 the switching element 4 can be a relay switch but also a semiconductor switch such as a NPN transistor, but other suitable switching elements could be applied as well. It is for instance even possible to use a hand operated switch. FIG. 2 further shows that between the spring 2 and the RC circuit 5 an element in the form of a diode 9 is comprised that enables electrical current to flow from spring 2 to RC circuit 5 and that blocks electrical current to flow back from RC circuit 5 to spring 2. Instead of the diode also a switched transistor could be applied.

To effectuate a measurement of a length variation of the spring 2, or a force or load applied to the spring 2, the electrical current flowing through the spring 2 is interrupted from flowing through the current path provided by the switching element 4 parallel to the RC circuit 5, and is forced to flow through the RC circuit 5, wherein a voltage decay time is measured of an electrical energy received by the RC circuit 5 upon interruption of the current flowing through the current path provided by the switching element 4 parallel to the RC circuit 5. This voltage decay time is used as a measure for the length variation, or the load or force applied to the spring 2. For this purpose, it is shown in FIG. 2 that at its output 6 the RC circuit 5 connects to a comparator 7 and a timer 8 to measure the voltage decay time of the RC circuit 5. The timer 8 is started upon the switching element 4 having moved into the second position in which electrical current through the spring 2 is interrupted to flow through the switching element 4 and forced to flow through the RC circuit 5.

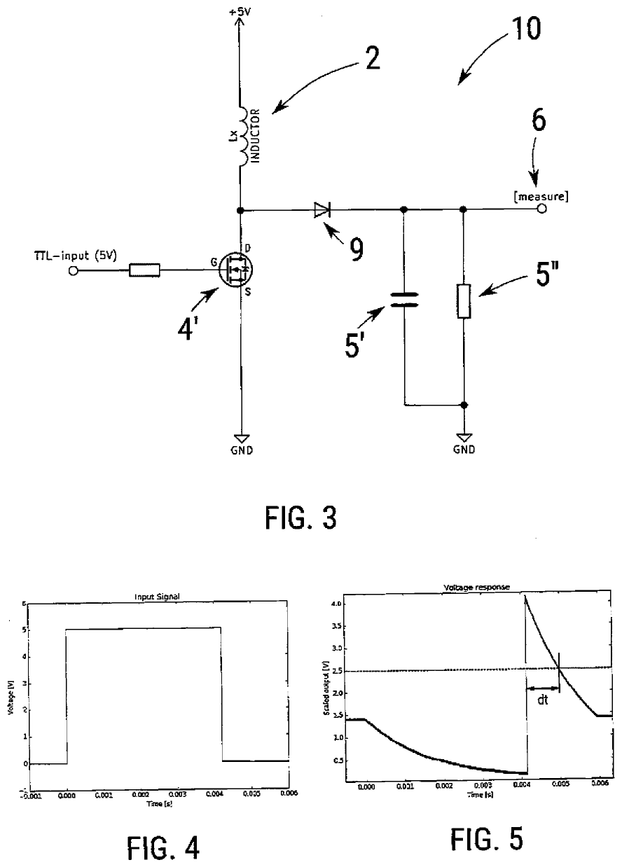

Another embodiment of a sensor according to an embodiment of the present invention with a MOSFET transistor 4′ as switching element is shown in FIG. 3, whereas FIG. 4 shows an input signal applied to the MOSFET transistor 4′, and FIG. 5 shows a measured voltage decay time at an output 6 of an RC circuit 5 connected to the MOSFET transistor 4′.

The rising edge of an input TTL-signal shown in FIG. 4 drives a gate g of an n-channel MOSFET transistor 4′ that becomes conductive between its drain d and source s pin. As a result, the spring 2 which is an inductive element, is connected to ground GND and starts establishing a magnetic field within the inductive element. After a certain time (usually in the ms range) when the spring 2 is magnetically fully saturated, the TTL-signal at the gate g pulls down. As a consequence, the connection between coil 2 and ground GND will be intermitted. The stored energy in the coil 2 will now flow into a capacitor 5′ of the RC circuit 5 via a diode 9, which ensures that current flows only toward the capacitor 5′.

By measuring the voltage decay time (dt) of the voltage over the capacitor 5′ trough a known resistor 5″ as shown in FIG. 5, the charge of the capacitor 5′ and thus the stored energy therein which corresponds to the length variation or the load that has been applied to the spring 2 can be measured. The measurement of the voltage decay time is preferably implemented in accordance with what is shown in FIG. 2, that is to say with a comparator 7 and a timer 8 to measure the voltage decay time of the RC circuit 5, wherein the timer 8 is started upon the MOSFET transistor 4′ having moved into the second position in which electrical current through the spring 2 is forced to flow through the RC circuit 5. The comparator 7 compares the voltage over the capacitor 5′ with a reference voltage of for instance 2.5 V. When the voltage over the capacitor 5′ drops below this value this gives the to be measured voltage decay time dt as shown in FIG. 5.

Although the invention has been discussed in the foregoing with reference to some exemplary embodiments, the invention is not restricted thereto and many variations are possible without departing from the invention. The discussed exemplary embodiments shall therefore not be used to construe the appended claims strictly in accordance therewith. On the contrary the embodiments are merely intended to explain the wording of the appended claims without intent to limit the claims to these embodiments. The scope of protection of the invention shall therefore be construed in accordance with the appended claims only, wherein a possible ambiguity in the wording of the claims shall be resolved using the exemplary embodiments.

Note that in the specification and claims, “about” or “approximately” means within twenty percent (20%) of the numerical amount cited.

1. An electrical displacement-, load- or force sensor comprising a spring forming an inductive sensor element for measuring an electrical parameter that varies depending on a displacement or a mechanical load or force on at least a part of the spring, wherein the spring is placed in series with an electrical circuit comprising in parallel a switching element and an RC circuit.

2. The electrical displacement-, load- or force sensor according to claim 1, wherein an electrical parameter relative to the RC circuit is used as a measure for the displacement, load or force applied to the spring.

3. The electrical displacement-, load- or force sensor according to claim 1, wherein the switching element comprises a first position in which electrical current is enabled to flow through the spring and through the switching element, and a second position in which electrical current through the spring is forced to flow through the RC circuit.

4. The electrical displacement-, load- or force sensor according to claim 2, wherein the electrical parameter relative to the RC circuit is an electrical energy that a capacitor of the RC circuit receives from the spring when the switching element is moved into the second position in which electrical current through the spring is forced to flow through the RC circuit.

5. The electrical displacement-, load- or force sensor according to claim 1, further comprising an element disposed between the spring and the RC circuit that enables electrical current to flow from the spring to the RC circuit and that blocks electrical current to flow from the RC circuit to the spring.

6. The electrical displacement-, load- or force sensor according to claim 5, wherein the element is a transistor or a diode.

7. The electrical displacement-, load- or force sensor according to claim 1, wherein the RC circuit connects to a comparator and a timer to measure a voltage decay time of the RC circuit.

8. The electrical displacement-, load- or force sensor according to claim 7, wherein the timer is started upon the switching element having moved into the second position in which electrical current through the spring is forced to flow through the RC circuit.

9. The electrical displacement-, load- or force sensor according to claim 1, wherein the switching element is a transistor.

10. A method for measuring a displacement-, load or force applied to at least a part of a spring, the method comprising:
providing that the spring is connected to an RC circuit and that the spring is energized through an electrical current flowing through the spring and through a current path parallel to the RC circuit;
interrupting the electrical current flowing through the spring from flowing through the current path parallel to the RC circuit and forcing it to flow through the RC circuit, wherein a voltage decay time of an electrical energy received by the RC circuit upon interruption of the current flowing through the current path parallel to the RC circuit is measured and used as a measure for the displacement, load or force applied to the spring.
